(19) United States
(12) Patent Application Publication
(10) Pub. No.: US 2025/0357771 A1
(43) Pub. Date: Nov. 20, 2025

(54) Multi-device Charging Dock

(71) Applicants: Michael Koufos, Jacksonville, FL (US); Simon Levin, Jacksonville, FL (US)

(72) Inventors: Michael Koufos, Jacksonville, FL (US); Simon Levin, Jacksonville, FL (US)

(21) Appl. No.: 18/665,522

(22) Filed: May 15, 2024

(51) Int. Cl. H02J 7/00; H01R 13/58

(52) U.S. Cl. CPC H02J 7/0045; H01R 13/5833; H02J 2207/30

(57) ABSTRACT

A multi-device charging dock comprising two rails and a plurality of device holders removably coupled between the two rails. Each of the device holders comprises a base and two flexible arms. The base has a substantially longitudinal configuration with a top surface, a bottom surface, a front surface, a rear surface, and two side surfaces, and further comprises a cable trough and a vertical channel configured to receive a charging cable. The cable trough is concaved along a longitudinal direction parallel to the length of the base and comprises at least one first openings on one of the two side surfaces. The vertical channel is concaved along a vertical direction perpendicular to the longitudinal direction and comprises a second opening on the top surface. The two arms extend upwards from the top surface of the base and configured to flex along the longitudinal direction to receive an electronic device.

### FIELD OF THE INVENTION

The present disclosure relates generally to charging docks and more specifically to a multi-device charging dock that comprises a plurality of electronic device holders aligned in an array for organization.

### BACKGROUND OF THE INVENTION

With the development of technology, electronic devices, especially portable phones and tablets, have become an essential tool for people to communicate, photograph, enhance productivity, access the internet, and enjoy entertainment in their daily lives. Overtime, charging electronic devices has been integrated into people's daily routine.

While it is understood that a variety of charging devices exist, some people may prefer using a charging dock over a charger with a cable. A charging dock keeps the charging area organized and typically holds the electronic device in a vertical position where a user can effortlessly place and grab the electronic device. Nevertheless, conventional charging docks are typically designed for singular electronic device.

In circumstances having multiple electronic devices, it may be a nuisance to grab a charging cable and find the corresponding charging port when charging cables are not organized or tangled together. Especially, separating tangled cables may be time-consuming and tedious.

Consequently, there is a need for a multi-device charging dock that provides convenience, easy accessibility, and organization.

### SUMMARY OF THE INVENTION

The following is a concise summary of the invention presented herein with the primary aim of providing a preliminary understanding of certain aspects of the invention. It should be noted, however, that this summary is not intended to serve as a comprehensive overview of the invention or the boundaries of its scope. Its sole purpose is to provide a rudimentary understanding of the invention's concept and features, which will be expounded upon in greater detail in the ensuing sections.

The present disclosure is generally directed towards to a multi-device charging dock with a plurality of device holders aligned in an array. An exemplary, nonlimiting embodiment of the present disclosure provides a multi-device charging dock, hereinafter referred to as the “charging dock”, which may be used to organize multiple portable electronic devices while connected to charging cables respectively. The charging dock generally comprises two spaced apart rails and a plurality of device holders disposed between and removably coupled to the two rails. Each of the device holders further comprises a base and two flexible arms. Respective charging cable are organized in the base and the two arms receive and hold the electronic device connected to the charging cable. The base and the two arms be integrally connected. It is preferable that the device holders be constructed of flexible material, such that the two arms may flex along the base, and the two rails be constructed of rigid materials, such as metal.

The base has a substantially longitudinal, rectangular prism configuration, and has a top surface, a bottom surface, a front surface, a rear surface, and two side surfaces. The base further comprises a cable trough along a longitudinal direction parallel to a length of the base and concaved from the front surface and extending towards the rear surface for a predetermined distance. The cable trough connects the two side surfaces and has a first opening on each of the two side surfaces. Preferably, the cable trough has a wavy configuration having a predetermined numbers of wave crests and wave troughs with various wave heights. The base further comprises a vertical channel along a vertical direction perpendicular to the longitudinal direction and also concaved from the front surface and extending towards the rear surface for a predetermined distance. The vertical channel connects the top surface and the bottom surface and has a second opening on the top surface, such that a connector of a charging cable may protrude through the second opening to connect the electronic device. Preferably, the second opening has a circular configuration partially overlapping the vertical channel, such that from a top view of the base, the second opening and the vertical channel form a lollipop configuration.

Turning to the two flexible arms, the two arms extend upwards from the top surface and are positioned on two opposite sides of the base. Each of the two arms has an outer surface and an inner surface opposite from the outer surface. The outer surfaces are extended from the two side surfaces and have a configuration with two slope-shaped protrusions and a longitudinal recess positioned between the two protrusions. The inner surface has an arched configuration and further comprises a vertical groove elongating along the arched inner surface from the top of the arm to the bottom of the arm.

Each of the two side surfaces of the base further comprises a connector configured to couple to one of the rails. Consequently, the device holders are aligned in an array between the two rails and configured to receive electronic devices and respective charging cables. Each of the individual charging cables comprises a connector and a cable. The cable may either pass through a left or right portion of the cable trough and turn to the vertical channel at an intersection of the cable trough and the vertical channel, with the connector received in the second opening. Respective electronic devices may then be docked on the device holder to connect to corresponding charging cables for charging.

The above features and advantages will become apparent from the following detailed description taken with the accompanying drawings.

### BRIEF DESCRIPTION OF DRAWINGS

FIG. 1 is a front perspective view of an exemplary embodiment of a modular device holder of a multi-device charging dock.

FIG. 2 is a rear perspective view of the exemplary embodiment of the modular device holder of the multi-device charging dock.

FIG. 3 is a front view of the exemplary embodiment of the modular device holder of the multi-device charging dock.

FIG. 4 a rear view of the exemplary embodiment of the modular device holder of the multi-device charging dock.

FIG. 5 is a right view of the exemplary embodiment of the modular device holder of the multi-device charging dock.

FIG. 6 is a left view of the exemplary embodiment of the modular device holder of the multi-device charging dock.

FIG. 7 is a top view of the exemplary embodiment of the modular device holder of the multi-device charging dock.

FIG. 8 is a bottom view of the exemplary embodiment of the modular device holder of the multi-device charging dock.

FIG. 9 depicts an electronic device, a charging cable, and the modular device holder unconnected.

FIG. 10 depicts the modular device holding the electronic device and connected to the charging cable.

FIG. 11 is a front perspective view of the multi-device charging dock.

FIG. 12 depicts multiple electronic devices disposed within the multi-device charging dock.

### NUMBER REFERENCES

1—Modular Device Charging Dock
10—Modular Device Holder
100—Base
102—Cable Trough
104—Vertical Channel
106—Connecting Member
110—Flexible Arms
112—Protrusion
114—Recess
116—Groove
200—Cable
202—Connector
300—Rail
400—Electronic Device

### DETAILED DESCRIPTION OF THE INVENTION

The following detailed description and accompanying drawings provide a comprehensive disclosure of an exemplary embodiment for the purpose of facilitating one of ordinary skill in the relevant art to make and use the invention. As such, the detailed description and illustration of the one or more exemplary embodiments presented herein are purely exemplary in nature and are not intended to limit the scope of the invention or its protection in any matter. It is further noted that the drawings may not be to scale, and in some cases, certain details may be omitted which are not necessary for an understanding of the present invention, such as conventional details of fabrication and assembly. Furthermore, there is no intention to be bound by any expressed or implied theory presented in the preceding technical field, background, brief summary or the following detailed description.

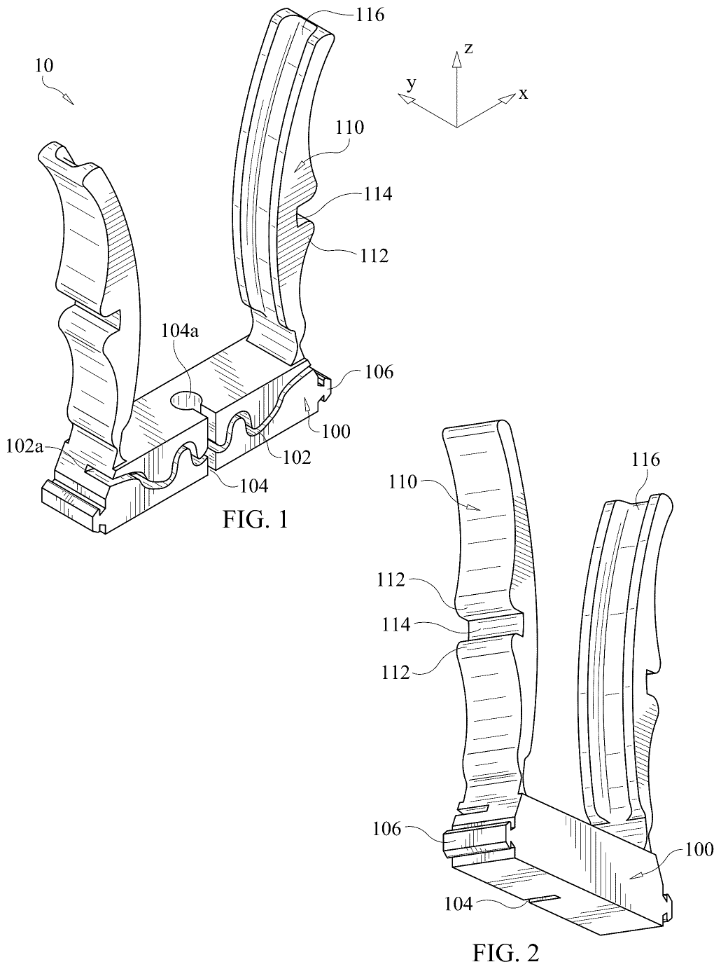

For purposes of description herein, the terms “top”, “bottom”, “side”, “outer”, “inner”, “left”, “right”, “inwards”, “outwards” and derivatives thereof shall relate to the device as oriented in FIG. 1. However, it should be understood that these terms are not intended to be limiting or absolute.

A non-limiting, exemplary embodiment of a multi-device charging dock (hereinafter as “the charging dock”) 1 is disclosed herein. The charging dock 1 organizes the space for charging multiple electronic devices and can mitigate the possibility of tangled charging cables, thereby providing convenience, easy accessibility, and aesthetic appeal to a user.

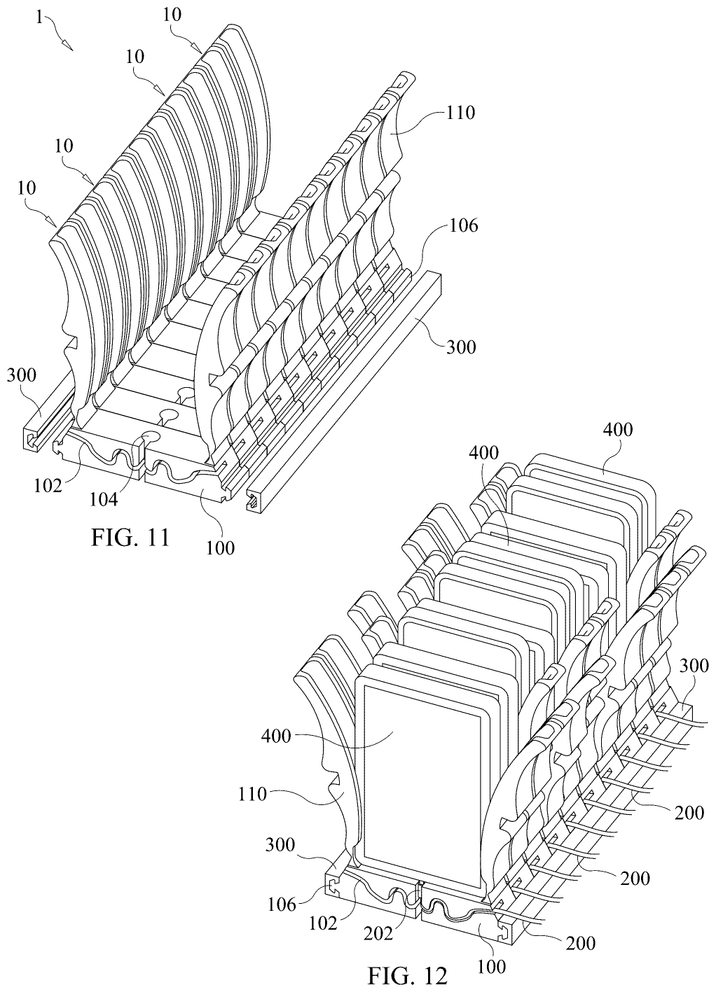

Referring initially to FIGS. 1 and 11, an individual device holder 10 and the charging dock 1 are illustrated in accordance with the exemplary embodiment. The charging dock comprises two rails 300 and a plurality of the device holders 10 aligned in an array between the two rails 300. Each of the device holders 10 is removably coupled to the two rails 300 by a connector 106 on two sides of each of the device holders 10.

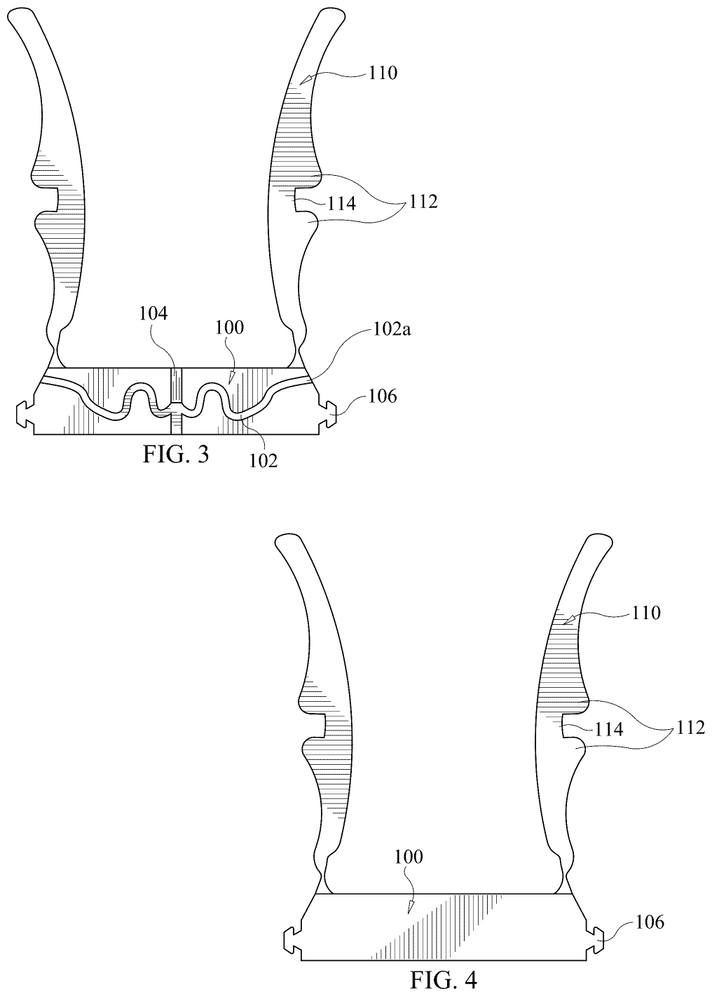

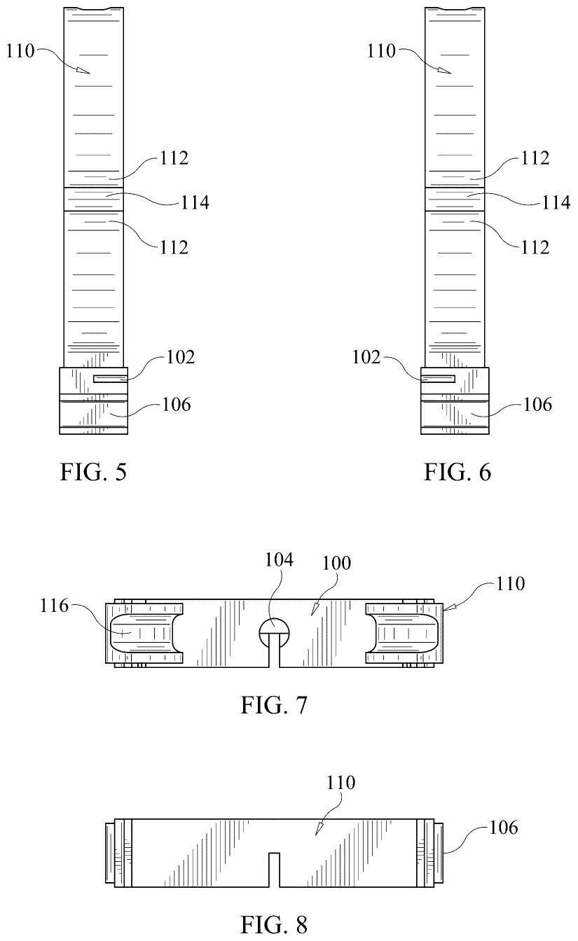

Turning to the device holder 10 and with reference to FIGS. 1 to 8, the device holder 10 generally comprises a base 100 and two flexible arms 110 extending upwards from the base 100. The base 100 has a substantially longitudinal, rectangular prism configuration with six surfaces, including a top surface, a bottom surface, a front surface, a rear surface, and two side surfaces. Further, the base 100 comprises a cable trough 102 and a vertical channel 104. The cable trough 102 extends along a longitudinal direction X, perpendicular to a transverse direction y, and a vertical direction z. As can be seen in FIG. 1, the cable trough 102 concaves from the front surface and extends towards the rear surface for a predetermined distance. The cable trough 102 also connects the two side surfaces of the base 100, as shown in FIG. 3, and has a first opening 102a on each of the two side surfaces. The vertical channel 104 extends along the vertical direction z and connects the top surface and the bottom surface, as shown in FIGS. 1 and 3. The vertical channel 104 divides the cable trough 102 into a left portion and a right portion. In the exemplary embodiment, the left portion and the right portion of the cable trough 102 each has a wavy configuration with equal numbers of wave crests and wave troughs with various wave heights. The left and right portions are symmetrical along the vertical channel 104. Moreover, in FIG. 1, the vertical channel 104 has a second opening on the top surface. In the exemplary embodiment, the second opening 104a has a circular configuration partially overlapping the vertical channel 104, such that from a top view of the base (FIG. 7), the second opening 104a and the vertical channel 104 form a lollipop configuration.

With continue reference to FIGS. 1 to 2, the two arms 110 extend from two opposite ends of the top surface of the base 100 in the vertical direction z. Each of the two arms 110 has an outer surface and an inner surface opposite from the outer surface. The outer surfaces extend from the two side surfaces and has a configuration with two slope-shaped protrusions 112 and a longitudinal recess 114 positioned between the two protrusions 112. The longitudinal recess 114 elongates along the transverse direction y. The inner surface has an arched configuration. Preferably, a span of the arched configuration is greater than the rise of the arch. Furthermore, the inner surface further comprises a groove 116 elongating in the vertical direction z and along the arched inner surface. The two arms 112 are constructed of flexible material, such that the two arms may flex inwards or outwards along the longitudinal direction x.

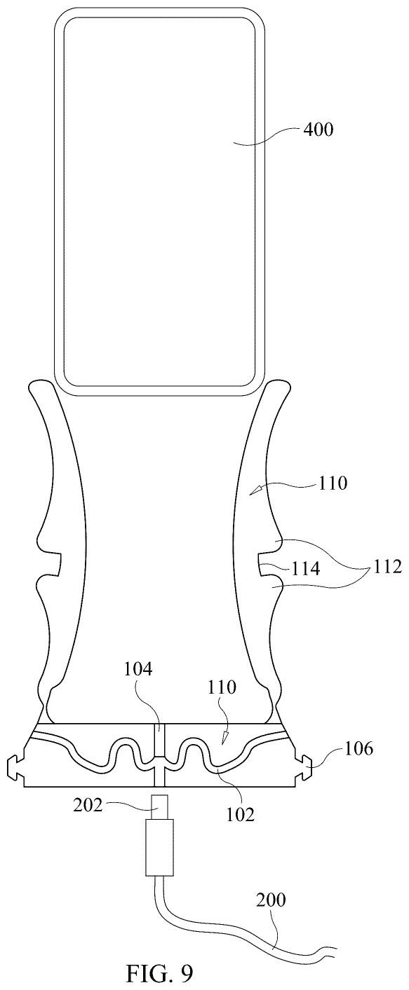

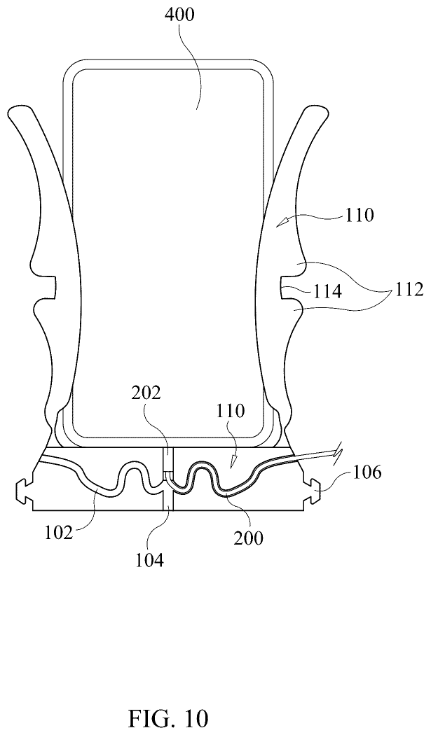

Referring to FIGS. 9-12, an exemplary method of using the charging dock 1 is presented herein to further demonstrate the convenience and how it organizes a plurality of electronic devices 400 and corresponding charging cables 200. It is anticipated that several steps may be sequentially interchangeable and equivalent application of one or more permutations of such sequentially interchangeable steps does not alter the spirit of the invention in any meaningful way.

First, an exemplary user directs a connector 202 of the charging cable 200 through the vertical channel 104 towards the second opening 104a and place the cable 200 either towards the left or right portion of the cable trough 102. Next, the exemplary user couples the plurality of device holders 10 to the two rails 300 by sliding the connectors 106 of each of the device holders 10 along the rails 300, such that the plurality of device holders 10 are aligned between the two rails 300. The charging dock 1 is ready for charging.

To charge the electronic devices 400, the exemplary user may simply slide their electronic devices 400 between the two arms 110 and towards the connector 202. The electronic device 400 glides along the groove 116 and urges the two arms 110 to flex outwards along the longitudinal direction x.

To remove the electronic devices 400 from the charging dock 1, the exemplary user may just grab the electronic devices 400 effortlessly from the charging dock 1. The two arms 110 flex back to their original position.

Advantageously, the charging cables 200 may be organized in the base 100 of the device holder 10 respectively and the flexible arms 112 may flex to receive electronic devices 400 having various width. The exemplary user may just easily place and grab the electronic devices 400 without specifically identifying a charging port of the electronic device 400 to connect with the charging cable 200 or untangle the charging cables. Moreover, the multiple electronic devices 400 being aligned in a single row provides a more organized and tidy space.

While the exemplary embodiment of the present disclosure has been disclosed, certain modifications may be made by those skilled in the art to modify the invention without departing from the spirit of the invention.

1. A device holder, comprising:
a base;
wherein the base has a substantially longitudinal configuration;
wherein the base has a top surface, a bottom surface, front surface, a rear surface, and two side surfaces;
wherein the base further comprises a cable trough and a vertical channel;
wherein the cable trough is concaved from the front surface and extends a predetermined distance towards the rear surface;
wherein the cable trough is concaved along a longitudinal direction parallel to a length of the base;
wherein the cable trough comprises at least one first openings on one of the two side surfaces;
wherein the vertical channel is concaved from the front surface and extends a predetermined distance towards the rear surface;
wherein the vertical channel is concaved along a vertical direction perpendicular to the longitudinal direction;
wherein the vertical channel comprises a second opening on the top surface; and
two arms;
wherein the two arms extend upwards from the top surface of the base;
wherein the two arms are configured to flex along the longitudinal direction.

2. The device holder as claimed 1, the cable trough has a wavy configuration.

3. The device holder as claimed 1, wherein the base further comprises two connectors, and wherein each of the two connectors is disposed on each of the two side surfaces respectively.

4. The device holder as claimed 3, wherein each of the two connectors is configured to couple to a rail.

5. The device holder as claimed 1, wherein the base and the two arms are integrally connected.

6. The device holder as claimed 1, wherein each of the two arms further comprises a groove on an inner surface of the each of the two arms.

7. The device holder as claimed 1, wherein an outer surface of each of the two arms has a configuration having two slope-shaped protrusions and a longitudinal recess; and wherein the recess is positioned between the two protrusions.

8. The device holder as claimed 1, wherein the cable trough connects the two side surfaces of the base.

9. The device holder as claimed 1, wherein the cable trough connects the top surface and the bottom surface of the base.

10. The device holder as claimed 1, wherein the device holder is symmetrical along a central axis parallel to the vertical direction.

11. A multi-device charging dock, comprising:
a. a plurality of device holders;
wherein the device holders are aligned in an array;
wherein each of the device holders comprises:
a base;
wherein the base has a substantially longitudinal configuration;
wherein the base has a top surface, a bottom surface, front surface, a rear surface, and two side surfaces;
wherein the base further comprises a cable trough and a vertical channel;
wherein the cable trough is concaved from the front surface and extends a predetermined distance towards the rear surface;
wherein the cable trough is concaved along a longitudinal direction parallel to a length of the base;
wherein the cable trough comprises at least one first opening on one of the two side surfaces;
wherein the vertical channel is concaved from the front surface and extends a predetermined distance towards the rear surface;
wherein the vertical channel is concaved along a vertical direction perpendicular to the longitudinal direction;
wherein the vertical channel comprises a second opening on the top surface;
wherein each of the two side surfaces comprises a connecter;
two arms;
wherein the two arms extend upwards from the top surface of the base;
wherein the two arms are configured to flex along the longitudinal direction; and
b. two rails;
wherein the rails are spaced apart and each of the rails is configured to couple to one of the connectors of one of the device holder;
wherein a length of the base is perpendicular to the two rails.

12. The multi-device charging dock as claimed 11, the cable trough has a wavy configuration.

13. The multi-device charging dock as claimed 11, wherein the base and the two arms are integrally connected.

14. The multi-device charging dock as claimed 11, wherein each of the two arms further comprises a groove on an inner surface of the each of the two arms.

15. The multi-device charging dock as claimed 11, wherein an outer surface of each of the two arms has a configuration having two slope-shaped protrusions and a longitudinal recess; and wherein the recess is positioned between the two protrusions.

16. The multi-device charging dock as claimed 11, wherein the cable trough connects the two side surfaces of the base.

17. The multi-device charging dock as claimed 11, wherein the cable trough connects the top surface and the bottom surface of the base.

18. The multi-device charging dock as claimed 11, wherein the device holder is symmetrical along a central axis parallel to the vertical direction.

19. The multi-device charging dock as claimed 11, wherein the rear surface of one of the device holder is adjacent to the front surface of the device holder aligned behind.

20. The multi-device charging dock as claimed 11, wherein the cable trough comprises two openings, and each of the two openings is positioned on each of the two side surfaces.
